(19) United States
(12) Patent Application Publication
(10) Pub. No.: US 2017/0162338 A1
(43) Pub. Date: Jun. 8, 2017

(54) Hybridized Electrode for a Hybrid Supercapacitor

(71) Applicant: Robert Bosch GmbH, Stuttgart (DE)

(72) Inventors: Elisabeth Buehler, Tamm (DE); Mathias Widmaier, Magstadt (DE); Pallavi Verma, Leinfelden (DE); Severin Hahn, Leonberg (DE); Thomas Eckl, Leonberg (DE)

(21) Appl. No.: 15/367,658

(22) Filed: Dec. 2, 2016

(30) Foreign Application Priority Data
Dec. 2, 2015 (DE) 10 2015 224 040.1

(51) Int. Cl. H01G 11/06; H01G 11/34; H01G 11/36; H01G 11/62; H01G 11/28; H01G 11/66; H01G 11/52; H01G 11/60; H01G 11/48; H01G 11/50

(52) U.S. Cl. CPC H01G 11/06; H01G 11/48; H01G 11/34; H01G 11/36; H01G 11/50; H01G 11/28; H01G 11/66; H01G 11/52; H01G 11/60; H01G 11/62

(57) ABSTRACT

A hybridized electrode includes from 5% by weight to 10% by weight of a binder which has a capacitance of at least 100 F/g. A hybrid supercapacitor includes at least one hybridized electrode of this type.

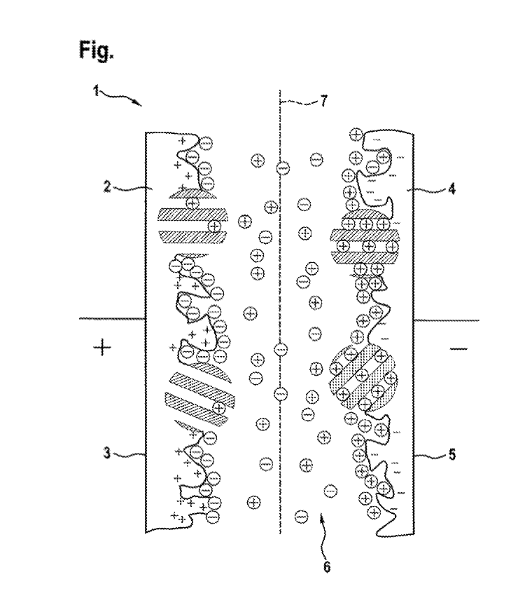

This application claims priority under 35 U.S.C. §119 to patent application no. DE 10 2015 224 040.1, filed on Dec. 2, 2015 in Germany, the disclosure of which is incorporated herein by reference in its entirety.

The present disclosure relates to a hybridized electrode. The present disclosure further relates to a hybrid supercapacitor containing at least one such hybridized electrode.

### BACKGROUND

Hybrid supercapacitors (HSCs), for example lithium ion capacitors, represent a new generation of capacitors. They have a higher energy density than high-energy supercapacitors (EDLCs/SCs), which although they can provide a power density of more than 100 kW/kg have only a low energy density. Since hybrid supercapacitors represent a new technology compared to other types of supercapacitors and to batteries, only a few products which use hybrid supercapacitors are commercially available at present.

As electrode material for hybrid supercapacitors, use is made of a mixture which is composed of a plurality of chemical substances comprising both Faraday materials and capacitively active materials and is bound by means of a binder to form a hybridized electrode.

Hybrid supercapacitors can, depending on the cell structure, be divided into two different categories: symmetric and asymmetric hybrid supercapacitors. Asymmetric hybrid supercapacitors have an electrode whose material stores energy by means of a reversible Faraday reaction. This can be a hybridized electrode. The second electrode is purely capacitive, i.e. it stores energy by formation of a Helmholz double layer. Lithium ion capacitors are an example of an asymmetric hybrid supercapacitor. Symmetric hybrid supercapacitors have two internally hybridized electrodes comprising both Faraday materials and capacitively active materials. This combination enables the power density to be increased appreciably compared to conventional supercapacitors. Furthermore, synergistic effects between the two active electrode materials in the two electrodes can be utilized. Symmetric hybrid supercapacitors are superior to asymmetric hybrid supercapacitors in pulsed operation.

### SUMMARY

The hybridized electrode which is, in particular, suitable for use in a hybrid supercapacitor contains from 5% by weight to 10% by weight of a binder. This percentage by weight specification is based, like all percentage by weight specifications below, on 100% by weight of the total hybridized electrode. The binder has an electrical capacitance of at least 100 F/g, in particular an electrical capacitance in the range from 100 F/g to 400 F/g. While the binder of conventional hybridized electrodes represents a dead mass which does not contribute to storage and transport of electric charges, a binder having the abovementioned capacitance has pseudocapacitive properties. As a result, this electrode has a higher capacitance than a conventional hybridized electrode which has otherwise the same composition and contains a conventional binder having a lower capacitance. Here, the binder of a hybridized electrode according to the disclosure contributes at least 5 F/g to the capacitance of the electrode.

The binder is preferably an electrically conductive polymer. Such polymers are also referred to as intrinsically conductive polymers and by means of conjugate double bonds attain an electrical conductivity which is comparable to that of metals. Electrically conductive polymers combine binder properties with a high electrical capacitance.

Particularly suitable electrically conductive polymers are selected from the group consisting of the following chemical compounds and mixtures thereof:
poly[3-(3,4-difluorophenyl)thiophene] (MPFPT),
polyaniline (PANT),
poly(1,5-diaminoanthraquinone) (DAAQ),
poly(3-methylthiophene) (P3MT, PMTh),
poly(3,4-ethylenedioxythiophene) (PEDOT, PEDT),
polypyrrole (PPy),
1H,1H,2H,2H-perfluorodecanethiol (PFDT),
poly(3,4-ethylenedioxythiophene)/polystyrenesulfonate mixture (PEDOT:PSS)

The hybridized electrode preferably contains from 15% by weight to 30% by weight of at least one lithium compound. This can contribute to the storage of electric charges by means of

Faraday Li⁺ intercalation reactions and Li⁺ deintercalation reactions. The binder can encapsulate the lithium compound and this stabilizes its high capacitance.

Furthermore, the hybridized electrode preferably contains from 60% by weight to 70% by weight of a carbon which is present in a modification selected from the group consisting of carbon nanotubes, carbon nanofibers, graphene, functionalized graphene, activated carbon and mixtures thereof. Such a carbon can likewise contribute to the storage of electric charges by means of its capacitive activity. The binder assists the carbon in this charge storage owing to its high capacitance. In addition, carbon as electrode constituent makes rapid energy provision of the electrode possible, since it improves the electrical conductivity of the electrodes. Owing to the high porosity of the carbon modifications used, these can also function as shock absorbers for high currents.

In addition to the capacitively active carbon, the hybridized electrode preferably contains 2-15% by weight of graphite and/or carbon black nanoparticles. This can increase the electrical conductivity of the electrode even further, so that graphite and carbon black nanoparticles can contribute to the transport of electric charges.

The hybrid supercapacitor has at least one hybridized electrode according to the disclosure. In one embodiment, it is configured as an asymmetric hybrid supercapacitor which contains a hybridized electrode according to the disclosure and a purely capacitive electrode. In another embodiment, it is configured as a symmetric hybrid supercapacitor. In this form, it can contain either a hybridized electrode according to the disclosure and a conventional hybridized electrode or two hybridized electrodes according to the disclosure. However, to be able to best exploit the advantages of the hybridized electrode according to the disclosure, preference is given to the supercapacitor containing two hybridized electrodes according to the disclosure.

The hybrid supercapacitor has, in particular, an electrolyte containing at least one electrolyte salt selected from the group consisting of LiClO₄, LiPF₆, LiBF₄, LiN(SO₂CF₃)₂ (also referred to as LITFSI), LiN(SO₂F)₂ (also referred to as LITFI), LiAsF₆, N(CH₃)BF₄, LiB(C₂O₄)₂ (also referred to as LiBOB), LiBF₂(C₂O₄) (also referred to as LiODFB), LiPF₃(CF₃CF₂)₃ (also referred to as LiFAP), LiCF₃SO₃ and LiN(SO₂C₂F₅)₂. These electrolyte salts have been found to be suitable for hybrid supercapacitors and can also be used in conjunction with the electrodes employed here.

Suitable solvents which ensure sufficient solubility of the electrolyte salt and do not react with the materials of the electrodes are, in particular, solvents selected from the following group: acetonitrile, propylene carbonate, ethylene carbonate, dimethyl carbonate, diethyl carbonate, ethylene methyl carbonate, ethyl methyl carbonate and mixtures thereof.

### BRIEF DESCRIPTION OF THE DRAWINGS

A working example of the disclosure is shown in the drawing and is described in more detail in the following description.

The FIGURE schematically shows the structure of a symmetric hybrid supercapacitor according to a working example of the disclosure.

### DETAILED DESCRIPTION

A hybrid supercapacitor 1 according to a first working example of the disclosure has the structure depicted in the FIGURE. A cathode 2 has been applied to a first collector 3. An anode 4 has been applied to a second collector 5. An electrolyte 6 has been introduced between the cathode 2 and the anode 4. A separator 7 separates the cathode 2 from the anode 4. Embedding of Li⁺ ions in the cathode 2 and in the anode 4 is shown schematically in the FIGURE. Here, the FIGURE shows activated carbon as capacitive electrode material on the surface of which negative charge carriers of the electrolyte 6 collect at the cathode 2 during the charging process and on the surface of which positive charge carriers of the electrolyte 6 collect at the anode 4. Furthermore, four enlargements show how the lithium ion cathode material of the cathode 2, in the present case LiMn₂O₄, deintercalates Li⁺ ions and the lithium ion anode material on the anode 4, in the present case Li₄Ti₅O₁₂, intercalates Li⁺ ions.

To produce the cathode 2, a mixture of 66.83 g of activated carbon, 15.67 g of LiMn₂O₄ particles and 5 g of carbon black nanoparticles is firstly produced. This is dry mixed in a mixer at 1000 rpm for 10 minutes. 90 ml of isopropanol are then added and the resulting suspension is firstly stirred at 2500 rpm for 2 minutes, then treated with ultrasound for 5 minutes and subsequently stirred at 2500 rpm for another 4 minutes. 7.5 g of polyaniline as binder are then added to the suspension and the mixture is stirred at 800 rpm for another 5 minutes until the suspension has a paste-like consistency. The paste is rolled onto a glass plate to give a 150 μm thick cathode 2 which is then applied to the first collector 3.

To produce the anode 4, a mixture of 66.83 g of activated carbon, 15.67 g of Li₄Ti₅O₁₂ particles and 5 g of carbon black nanoparticles is firstly produced. This is dry mixed in the mixer at 1000 rpm for 10 minutes. 90 ml of isopropanol are then added and the resulting suspension is firstly stirred at 2500 rpm for 2 minutes, then treated with ultrasound for 5 minutes and subsequently stirred at 2500 rpm for another 4 minutes. 7.5 g of polyaniline as binder are then added to the suspension and the mixture is stirred at 800 rpm for another 5 minutes until the suspension has a paste-like consistency. The paste is rolled onto a glass plate to give a 150 μm thick anode 4 which is then applied to the second collector 5.

A 1 M solution of LiClO₄ in acetonitrile is used as electrolyte 6. The separator 7 consists of a woven polyamide/polyethylene terephthalate/cellulose fabric having a porosity of 62%.

The polyaniline which is used as binder in the cathode 2 and in the anode 4 has a capacitance of 190 F/g. The proportion of 7.5 g of polyaniline per 100 g of the electrode composition produced in each case thus contributes 14.25 F/g to the capacitance of the cathode 2 and of the anode 4. The electrodes of this hybrid supercapacitor therefore have a higher capacitance than the electrodes of a comparable conventional hybrid supercapacitor which contains, for example, polytetrafluoroethylene as binder in place of the polyaniline. In the conventional hybrid supercapacitor, the polytetrafluoroethylene represents a dead mass which does not contribute to the electrical properties of the electrodes.

What is claimed is:

1. A hybridized electrode, comprising:
a binder that constitutes from 5% by weight to 10% by weight of the electrode, and that has a capacitance of at least 100 F/g.

2. The hybridized electrode of claim 1, wherein the binder is an electrically conductive polymer.

3. The hybridized electrode of claim 2, wherein the binder is selected from a group consisting of poly[3-(3,4-difluorophenyl)thiophene], polyaniline, poly(1,5-diaminoanthraquinone), poly(3-methylthiophene), poly(3,4-ethylenedioxythiophene), polypyrrole, 1H,1H,2H,2H-perfluorodecanethiol, poly(3,4-ethylenedioxythiophene)/polystyrenesulfonate mixture and mixtures thereof.

4. The hybridized electrode of claim 1, further comprising:
at least one lithium compound that constitutes from 15% by weight to 30% by weight of the electrode.

5. The hybridized electrode of claim 1, further comprising:
a carbon that constitutes from 60% by weight to 70% by weight of the electrode, and that is selected from a group consisting of carbon nanotubes, carbon nanofibers, graphene, functionalized graphene, activated carbon and mixtures thereof.

6. The hybridized electrode of claim 1, further comprising:
at least one of (i) graphite and (ii) carbon black nanoparticles that constitute from 2% by weight to 15% by weight of the electrode.

7. A hybrid supercapacitor, comprising:
at least one hybridized electrode that includes:
a binder that constitutes from 5% by weight to 10% by weight of the electrode, and that has a capacitance of at least 100 F/g.
